(19) United States
(12) Patent Application Publication
(10) Pub. No.: US 2016/0327442 A1
(43) Pub. Date: Nov. 10, 2016

(54) OPTICAL FIBER STRAIN SENSOR SYSTEM AND METHOD

(71) Applicant: Avago Technologies General IP (Singapore) Pte. Ltd., Singapore (SG)

(72) Inventors: Dawid Z. Janse Van Vuuren, Pentling (DE); Magnus Ahlstedt, Regensburg (DE); Milos Davidovic, Vienna (AT); Wolfgang Gaberl, Vienna (AT); Markus Schwarzfischer, Roding (DE)

(21) Appl. No.: 14/703,963

(22) Filed: May 5, 2015

(51) Int. Cl. G01L 1/24

(52) U.S. Cl. CPC G01L 1/242

(57) ABSTRACT

An optical fiber strain sensor system and method are provided that prevent mechanical stresses exerted on the portions of the optical transmission path that leads from the measurement equipment to the structure and that leads from the structure back to the measurement equipment from having an influence on the phase difference measurement. In addition, the optical strain sensor system and method can be implemented with a reduced amount of optical fiber and a reduced number of optical connectors, thereby reducing overall system cost while improving measurement accuracy.

### TECHNICAL FIELD

The invention relates to strain sensor technology, and more particularly, to an optical fiber strain sensor system and method.

### BACKGROUND

In recent years, optical fibers have been used as strain sensors for sensing the strain, or stress, placed on a structure. The structure may be, for example, a concrete piling used in a building, a tower, a rotor blade of a windmill, or a wing of an airplane. In such environments, a portion of the strain-sensing fiber is embedded in or attached to the structure. Typically, an adhesive material, such as epoxy, is used to attach the strain-sensing fiber to the structure. The ends of the strain-sensing fiber are optically coupled to measurement equipment. A reference optical fiber is typically laid alongside the strain-sensing fiber on the structure to which the strain-sensing fiber is attached. The ends of the reference fiber are also optically coupled to the measurement equipment.

An optical source of the measurement equipment, such as a laser diode or a light emitting diode (LED), for example, is modulated to produce a modulated light beam. An optical splitter of the measurement equipment splits the modulated light beam into first and second modulated light beams, which are then optically coupled into the first ends of the strain-sensing fiber and the reference fiber. The first and second modulated light beams propagate along the two fibers and pass out of the second ends of the fibers. The measurement equipment includes first and second optical sensors that receive the respective light beams and convert the respective light beams into respective electrical signals. Electrical circuitry of the measurement equipment processes the electrical signals to determine the phase differences between them. The phase differences are then used to determine the difference in the lengths of the two fibers.

If stress on the strain-sensing fiber has caused it to become elongated, the measurement equipment will calculate the extent of the elongation over time based on the measured phase differences. The extent of the elongation over time may be used to characterize the strain or stress that has been placed on the structure over time, which, in turn, may be used as a factor in determining the integrity of the structure.

One of the challenges with the current approach is that any mechanical stresses that are placed on the strain-sensing fiber along the portion of the transmission path that extends from the optical splitter to the structure and from the structure to the measurement equipment can have an influence on the optical signal. This influence can reduce the accuracy of the stress measurement. The current solution for minimizing this influence is to run both fibers together in the same cable from the optical splitter to the structure and from the structure to the measurement equipment. By running the fibers in the same cable, they are equally influenced by mechanical stresses placed on the cable, which allows the influence to be ignored because it has very little effect on the phase difference measurement. This solution, however, requires a relatively large amount of optical fiber, which can increase costs. In addition, even small movements (micrometer range) of the optical connectors that are used to connect the ends of the optical fibers to various optical coupling points in the system can reduce the accuracy of the stress measurement.

A need exists for a strain sensing system and method that provide an effective solution for eliminating the influence that mechanical stresses can have on the optical signal being transmitted over the portion of the transmission path that extends from the optical splitter to the structure and from the structure to the measurement equipment. A need also exists for an effective solution to this problem that reduces the amount of optical fiber and the number of optical connectors that are used in the system, thereby reducing overall costs and further improving stress measurement accuracy.

### BRIEF DESCRIPTION OF THE DRAWINGS

FIG. 1 illustrates the optical fiber strain sensor system in accordance with an illustrative embodiment.

FIG. 2 illustrates the optical fiber strain sensor system in accordance with another illustrative embodiment.

FIG. 3 illustrates a graph of a set of base triangles representing a correlation triangle for N=16 phase steps.

FIGS. 4 and 5 illustrate graphs of the base triangles t₅ and t₆, respectively, for a correlation triangle whose tip falls in between phase steps N=5 and N=6, respectively.

FIG. 6 illustrates a graph of the correlation triangle that is represented in part by a linear combination of base triangles that includes base triangles t₅ and t₆ shown in FIGS. 4 and 5, respectively.

FIG. 7 illustrates the optical fiber strain sensor system shown in FIG. 2 showing an illustrative embodiment of the components of the optical transceiver shown in FIG. 2.

FIG. 8 illustrates a flowchart that represents the method in accordance with an illustrative embodiment for sensing strain in an optical fiber using a system of the type shown in FIGS. 1, 2 and 7.

### DETAILED DESCRIPTION OF ILLUSTRATIVE EMBODIMENTS

Illustrative, or exemplary, embodiments disclosed herein are directed to an optical fiber strain sensor system and method that prevent mechanical stresses exerted on the portions of the optical transmission path that leads from the measurement equipment to the structure and that leads from the structure back to the measurement equipment from having an influence on the phase difference measurement. In addition, the optical strains sensor system and method can be implemented with a reduced amount of optical fiber and a reduced number of optical connectors, thereby reducing overall system cost while improving measurement accuracy.

In accordance with an illustrative embodiment, an optical splitter is located in very close proximity to the structure so that mechanical stresses exerted on a transmit optical fiber that carries an optical signal from the light source of the measurement equipment to the structure will have no influence on the phase difference measurement. The optical splitter splits the optical signal into a measurement optical signal and a reference optical signal, which are coupled into first ends of a measurement optical fiber and a reference optical fiber, respectively. An optical combiner located in close proximity to the structure combines the optical signals passing out of second ends of the reference and measurement optical fibers into a combined optical signal, which is then carried over a receive optical fiber to the measurement equipment. Because separate receive optical fibers are not used to carry separate reference and measurement optical signals to the measurement equipment, mechanical stresses exerted on the receive optical fiber also will have no influence on the phase difference measurement.

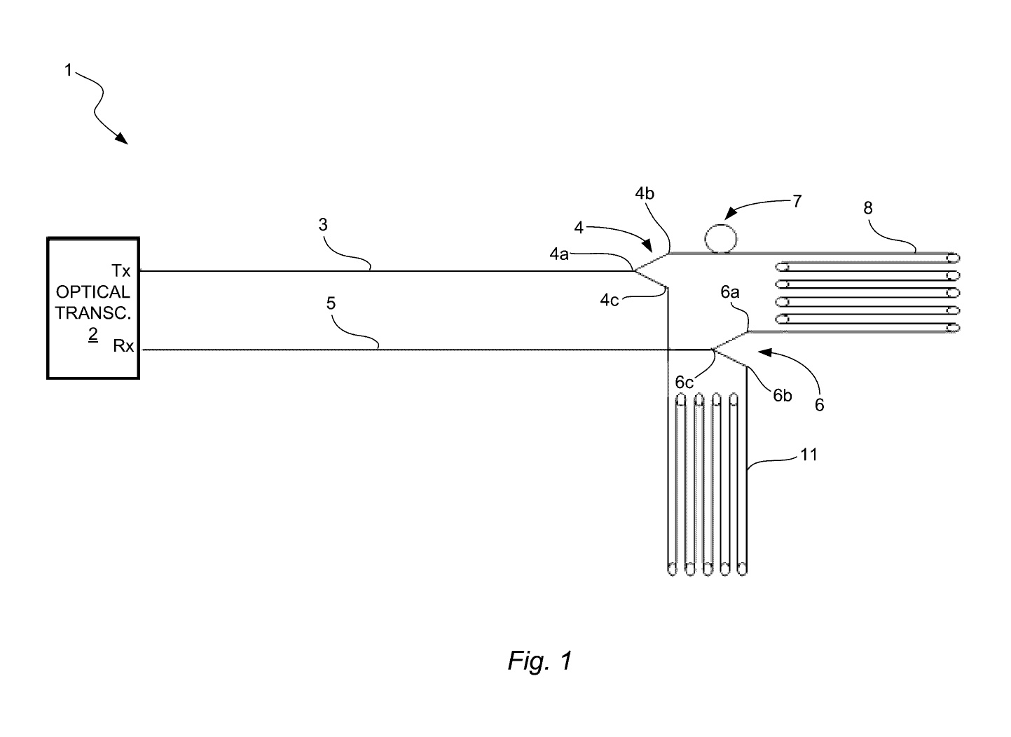

Illustrative embodiments will now be described with reference to FIGS. 1-8, in which like reference numerals identify like elements, components or features. It should be noted that features, elements or components shown in the figures are not necessarily drawn to scale, emphasis instead being placed on demonstrating the principles and concepts of the invention.

FIG. 1 illustrates the optical fiber strain sensor system 1 in accordance with an illustrative embodiment. In accordance with this embodiment, the measurement equipment comprises an optical transceiver 2 having at least a first transmit channel and a first receive channel. The transmit channel includes a light source (not shown) such as an LED or a laser diode, for example, and driver circuitry (not shown) for modulating and driving the light source, as will be described below in more detail. A transmit optical fiber 3 has a first end that is mechanically and optically coupled to the transmit channel of the optical transceiver 2 and a second end that is mechanically and optically coupled to an input port 4a of an optical splitter 4 of the system 1. The optical splitter 4 is located in very close proximity to a structure (not shown) being measured. For practical purposes, the optical splitter 4 may be assumed to be located on or in the structure in that the distance between the optical splitter 4 and the structure is negligible in terms of its effect on the phase difference measurements.

The receive channel of the optical transceiver 2 includes an optical detector (not shown), such as a p-intrinsic-n (PIN) diode, for example, and receiver circuitry (not shown), such as a transimpedance amplifier (TIA), clock and data recovery (CDR) circuitry, and a processor, for example. A receive optical fiber 5 has a first end that is mechanically and optically coupled to the receive channel of the optical transceiver 2 and a second end that is mechanically and optically coupled to an output port 6c of an optical combiner 6 of the system 1. The optical combiner 6 is also located in very close proximity to the structure being measured. For practical purposes, the optical combiner 6 may be assumed to be located at or on the structure in that the distance between the optical combiner 6 and the structure is negligible in terms of its effect on the phase difference measurements.

A first output port 4b of the optical splitter 4 is mechanically and optically coupled to a first end of a delay optical fiber 7 of the system 1. A second end of the delay optical fiber 7 is mechanically and optically coupled to a first end of a measurement optical fiber 8 of the system 1. The measurement optical fiber 8 is secured at one or more locations thereof to a structure (not shown) in which the system 1 is being used to measure strain or stress. By securing the measurement optical fiber 8 to the structure, strain or stress in the structure creates strain or stress on the measurement optical fiber 8. The receive optical fiber 5 is typically located in close proximity to the measurement optical fiber 8, but is not secured to the structure in a way that will allow strain or stress in the structure to induce strain or stress in the receive optical fiber 5.

The second end of the measurement optical fiber is mechanically and optically coupled to a first input port 6a of the optical combiner 6. A first end of a reference optical fiber 11 of the system 1 is mechanically and optically coupled to a second output port 4c of the optical splitter 4. A second end of the reference optical fiber 11 of the system 1 is mechanically and optically coupled to a second input port 6b of the optical combiner 6. In accordance with this illustrative embodiment, the measurement and reference optical fibers 8 and 11 are of equal length.

It should be noted that while the system 1 is shown and described as using optical fibers 3, 5, 7, 8, and 11 for carrying the optical signals, other types of optical waveguides may be used for this purpose. The optical waveguides that are used in the system 1 are typically glass or plastic optical fibers. The invention, however, is not limited with respect to the types of optical waveguides that are used in the system 1 or with respect to the types of materials that are used to make the waveguides.

The system 1 operates as follows. The optical transceiver 2 generates a modulated optical signal that is coupled into the first end of the transmit optical fiber 3. The optical splitter 4 receives the modulated optical signal at its input port 4a and splits the modulated optical signal into first and second modulated optical signals. The first and second modulated optical signals will be referred to herein as measurement and reference optical signals, respectively. The measurement and reference optical signals are output from output ports 4b and 4c, respectively, of the optical splitter 4. The measurement optical signal then travels through the delay fiber 7 before entering the first end of the measurement optical fiber 8. The reference optical signal enters the first end of the reference optical fiber 11.

The delayed measurement optical signal and the reference optical signal travel through the measurement and reference optical fibers 8 and 11 and arrive at the input ports 6a and 6b of the optical combiner 6, respectively. The delay fiber 7 creates a predetermined time delay that time shifts the measurement optical signal relative to the reference optical signal in the time domain. The purpose of the time shift is described below in more detail with respect to a signal processing algorithm that is used to extract the phases of the measurement and reference optical signals. The delay fiber 7 could instead be connected on one end to port 4c of the optical splitter 4 and on the opposite end to the first end of the reference optical fiber 11 or the delay fiber 7 could be connected on one end to the second end of the reference optical fiber 11 and on the opposite end to port 6b of the optical combiner 6. In other words, it doesn't matter whether the measurement optical signal or the reference optical signal is delayed.

The optical combiner 6 combines the measurement and reference optical signals into a combined modulated optical signal and outputs the combined modulated optical signal from output port 6c of the optical combiner 6. The combined modulated optical signal enters the second end of the receive optical fiber 5 and travels along fiber 5 to the optical transceiver 2, which receives the combined modulated optical signal at the receive channel input terminal of the transceiver 2.

Inside of the optical transceiver 2, the combined modulated optical signal is converted into an electrical signal and processed by a signal processing algorithm to extract the phases of the reference and measurement optical signals and to determine the difference between the extracted phases. The manner in which the electrical signal is processed to extract the phases and to determine the phase difference is described below in detail.

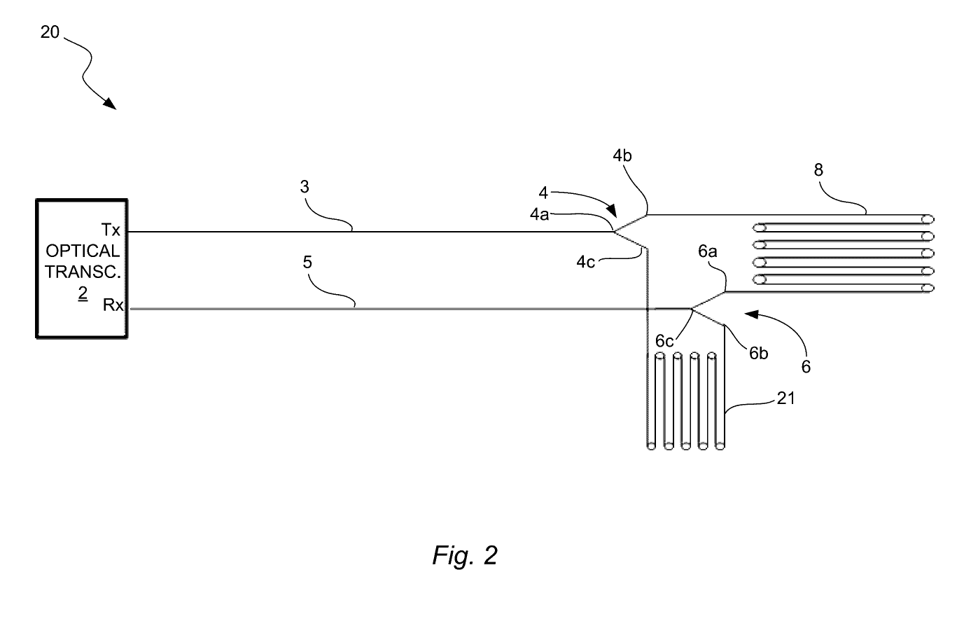

FIG. 2 illustrates the optical fiber strain sensor system 20 in accordance with an illustrative embodiment. The system 20 is identical to the system 1 shown in FIG. 1 except that the delay fiber 7 of system 1 has been eliminated and the reference optical fiber 21 is shorter than the measurement optical fiber 8 of system 1 by an amount equal to the length of the delay fiber 7. The system 20 operates as follows. The optical transceiver 2 generates a modulated optical signal that is coupled into the first end of the transmit optical fiber 3. The optical splitter 4 receives the modulated optical signal at its input port 4a and splits the modulated optical signal into a modulated measurement optical signal and a modulated reference optical signal, respectively. The measurement and reference optical signals are output from output ports 4b and 4c, respectively, of the optical splitter 4. The measurement optical signal enters the first end of the measurement optical fiber 8. The reference optical signal enters the first end of the reference optical fiber 21.

The measurement and reference optical signals travel through the measurement and reference optical fibers 8 and 21, respectively, and arrive at the input ports 6a and 6b of the optical combiner 6, respectively. The measurement optical signal is delayed in time relative to the reference optical signal by a predetermined amount due to the shorter length of the reference optical fiber 21 relative to the length of the measurement optical fiber 8. As indicated above, the purpose of the time delay is described below in detail with reference to the signal processing algorithm that is used to extract the phases of the measurement and reference optical signals. The reference optical fiber 21 could instead be made longer than measurement optical fiber 8 such that the reference optical signal is delayed by the predetermined amount relative to the measurement optical signal. As indicated above, it does not matter whether the reference optical signal or the measurement optical signal is delayed.

The optical combiner 6 combines the measurement and reference optical signals into a combined modulated optical signal and outputs the combined modulated optical signal from output port 6c of the optical combiner 6. The combined modulated optical signal enters the second end of the receive optical fiber 5 and travels along the receive fiber 5 to the optical transceiver 2, which receives the combined optical signal at the receive channel input terminal of the transceiver 2. Inside of the optical transceiver 2, the combined modulated optical signal is converted into an electrical signal by the optical detector (e.g., PIN diode, an avalanche photodiode (APD), a single photon avalanche diode (SPAD), etc.) of the transceiver 2 and processed by the processor of the transceiver 2 in accordance with a signal processing algorithm to extract the phases of the measurement and reference optical signals and to determine the difference between the extracted phases. An illustrative embodiment of the signal processing algorithm that is used to process the electrical signal to extract the phases is described below in detail.

It should be noted that although separate transmit and receive optical fibers 3 and 5 are shown in FIGS. 1 and 2, a single optical fiber may be used to carry the modulated optical signal from the transceiver 2 to the optical splitter 4 and to carry the combined modulated optical signal from the optical combiner 6 to the transceiver 2 provided that additional splitting and merging operations on the optical signals are performed at appropriate locations in the system.

The combined modulated optical signal corresponds to the measurement and reference optical signals superimposed on one another. In general, the signal processing algorithm uses a time of flight (TOF) principle to extract the phases of the superimposed signals. The electrical signal that is produced by the optical detector of the transceiver 2 and the clock signal that is used by the driver circuitry of the transceiver 2 to drive the light source of the transceiver 2 are of rectangular or rectangular-like shape. The signal processing algorithm cross-correlates the electrical signal produced by the optical detector with the clock signal used by the driver circuitry of the transceiver 2 to modulate the light source.

Because the cross-correlation function of two rectangular signals is a function having a triangular shape, the result of the cross-correlation process is a cross-correlation signal having a triangular shape, which will be referred to hereinafter as the correlation triangle. The correlation triangle can be represented by a linear combination of base triangles having corresponding amplitudes. A representation of the correlation triangle as a linear combination of base triangles is generated. The well-known Method of Least Squares algorithm is then used to derive the amplitudes of the linear combination of base triangles. The phase of the correlation triangle is then derived from the amplitudes of the linear combination of base triangles.

Because the combined modulated optical signal is a superimposition of two modulated optical signals, an assumption is made that the cross-correlation function of the superimposed signal is composed of the sum of the cross-correlation functions of the measurement and reference optical signals i.e., the sum of two correlation triangles. An ideal triangle can always be expressed as the sum of two dislocated triangles in the triangle domain. In reality, the cross-correlation functions of each of the two signals will not be ideal triangles, but will be smoothed representations of them due to the limited bandwidth of the system. As a consequence, each correlation triangle may be represented by, for example, the combination of four based triangles. If the superimposed signals are shifted enough in the time domain so that each has its own representation in the triangle domain that does not overlap the other, their respective phases can be successfully distinguished from one another. In other words, if the two correlation triangles have a phase delay of, for example, 90°, they will not overlap in the triangle domain, which will allow their phases to be successfully distinguished and extracted.

The predetermined time delay of the measurement optical signal relative to the reference optical signal described above with reference to FIGS. 1 and 2 ensures that the phases of these signals will be far enough apart that performing the cross-correlation process on the combined modulated optical signal will result in two correlation triangles: a first correlation triangle corresponding to the measurement optical signal and a second correlation triangle corresponding to the reference optical signal. The first and second correlation triangles can then be represented as first and second linear combinations of base triangles, respectively. The Method of Least Squares is performed on the first and second linear combinations of base triangles to derive first and second sets of amplitude values. The first and second sets of amplitude values are then processed to derive first and second phase values. The first and second phase values correspond to the respective phases of the first and second correlation triangles. The phase difference is then obtained by taking the difference between the first and second phase values. As is well understood in the art of optical fiber strain sensors, the phase difference may then be used to determine a change in the length of the measurement optical fiber caused by stress or strain in the structure.

The manner in which cross-correlation and the Method of Least Squares may be used to determine the phase of a signal was described in an article entitled “A processing approach for a correlating time-of-flight range sensor based on a least squares method,” by Michael Hofbauer, Johannes Seiter, Milos Davidovic and Horst Zimmermann, published in IEEE Sensors Applications Symposium (SAS), 2014, pp. 355-359, published in February 2014, which is incorporated herein by reference. In accordance with the invention, it has been determined that the principles described therein can be applied in cases where the signal being cross-correlated is composed of two signals that are superimposed on one another and that have sufficiently different phases that two correlation triangles are produced that do not overlap one another in the triangle domain. The principles disclosed in the article that are applied to the illustrative embodiments will now be described.

A correlation triangle is represented in N discrete phase steps, where N is a positive integer that is greater than or equal to 2. For exemplary purposes, it will be assumed that N is equal to 16, although N could be a greater or lesser number. The measured correlation triangle with N phase steps is interpreted as N-dimensional vector ψ, whereas N has to be an even number. The measured correlation triangle may be represented as a linear combination of N/2 base triangles which build a subspace in R^{N}, where R is a Gramian matrix of the set of base triangles that represents the correlation triangle. Gramian matrices have a well-known meaning in linear algebra and therefore will not be defined herein in the interest of brevity.

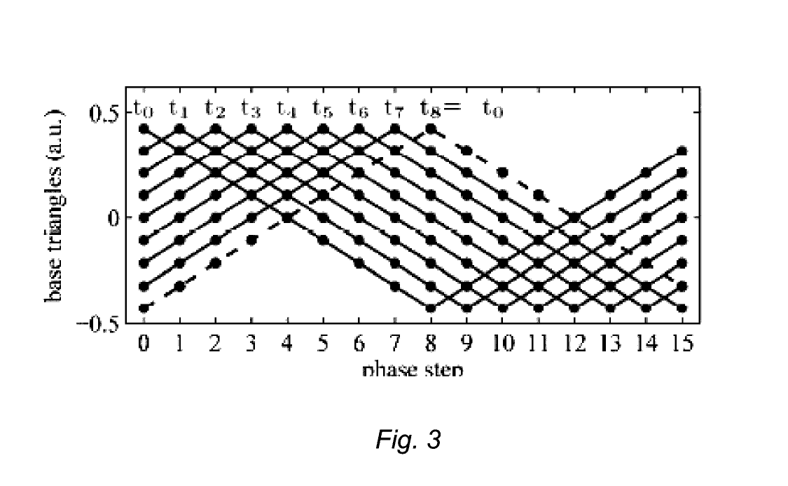

FIG. 3 illustrates a graph of a set of base triangles representing a correlation triangle for N=16 phase steps. The base triangles, tᵢ, where i=N/2, are chosen in such a way that the tip of each of the base triangles is located at one of the phase steps. It should be noted that there are only eight linearly independent base triangles in R¹⁶, as base triangles t₈ to t₁₅ are just negative versions of the base triangles t₀ to t₇, respectively.

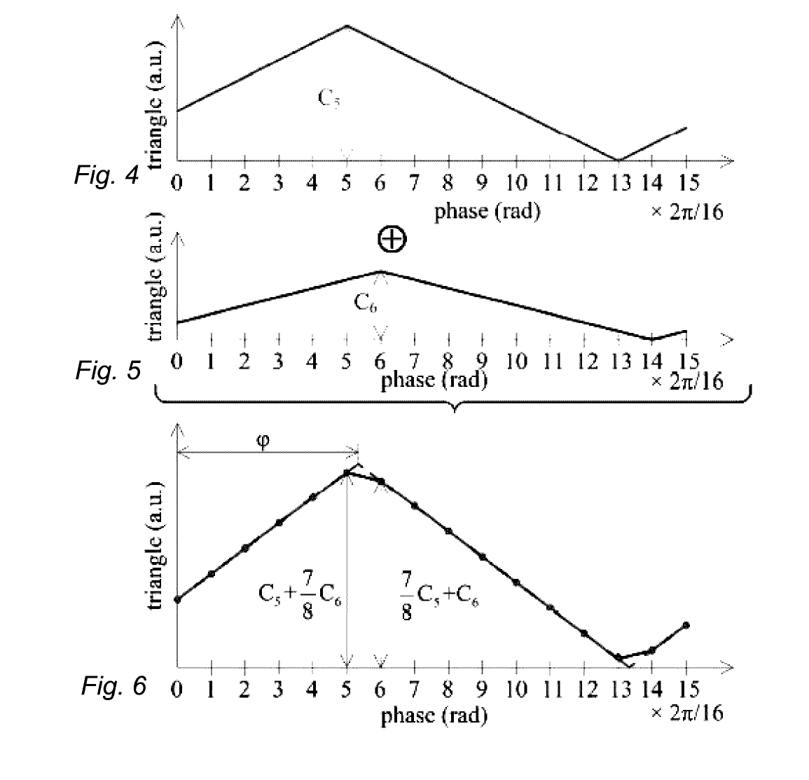

FIGS. 4 and 5 illustrate graphs of the base triangles t₅ and t₆, respectively, for a correlation triangle whose tip falls in between phase steps N=5 and N=6, respectively. FIG. 6 illustrates a graph of the correlation triangle that is represented in part by a linear combination of base triangles that includes base triangles t₅ and t₆ shown in FIGS. 4 and 5, respectively. The vertical axes of the graphs represent amplitude and the horizontal axes represent phase in radians. The correlation triangle shown in FIG. 6 corresponds to the sum of the two base triangles t₅ and t₆, shown in FIGS. 4 and 5, respectively. The tips of the base triangles t₅ and t₆ correspond to amplitudes C5 and C6, respectively. The amplitudes C5 and C6 of the base triangles define the phase of the resulting correlation triangle. This phase of the correlation triangle can be expressed using simple trigonometry as:

$$ϕ = \frac{5 {C}_{5} + 6 {C}_{6}}{{C}_{5} + {C}_{6}} \frac{2 π}{16} \qquad Equation 1$$

For a general correlation triangle, the relationship between phase of the correlation triangle and the two adjacent base triangles can be expressed as:

$$ϕ = \frac{{iC}_{i} + ( i + 1 ) {C}_{i + 1}}{{C}_{i} + {C}_{i + 1}} \frac{2 π}{N} , {C}_{i} \geq 0 \qquad Equation 2$$

The relationship given in Equation 2 is valid for phases ranging from φ=0 radians to φ=π radians. For the remaining range of phases, the negative copies of the base triangles have to be taken into account. The phase of the negative copy of each base triangle is shifted by π radians relative to the phase of the respective base triangle. Therefore, the phase of a correlation triangle that lies between two adjacent negative copies of base triangles may be expressed as:

$$ϕ = \frac{( i + \frac{N}{2} ) \vert {C}_{i} \vert + ( i + 1 + \frac{N}{2} ) \vert {C}_{i + 1} \vert}{\vert {C}_{i} \vert \vert \vert {C}_{i + 1} \vert} \frac{2 π}{N} , {C}_{i} \geq 0 \qquad Equation 3$$

Each correlation triangle ψ can be represented by a linear combination of the base triangles tᵢ with the corresponding amplitudes Cᵢ as:

$$Ψ = {\sum }_{i = 0}^{\frac{N}{2} - 1} {C}_{i} {t}_{i} \qquad Equation 4$$

The Method of Least Squares may then be used to derive the amplitudes Cᵢ of the linear combination of base triangles for a given correlation triangle ψ. The amplitudes can be calculated as:

$$c = {[ {C}_{0} , {C}_{1} , … , {C}_{\frac{N}{2} - 1} ]}^{T} = {R}^{- 1} p \qquad Equation 5$$

where R is the Gramian matrix of the set of base triangles that may be expressed as:

$$R = [ \begin{matrix}{t}_{0} \cdot {t}_{0} & … & {t}_{\frac{N}{2} - 1} \cdot {t}_{0} \\ ⋮ & ⋱ & ⋮ \\ {t}_{0} \cdot {t}_{\frac{N}{2} - 1} & … & {t}_{\frac{N}{2} - 1} \cdot {t}_{\frac{N}{2} - 1}\end{matrix} ] \qquad Equation 6$$

where p is defined as:

$$p = {[ ψ \cdot {t}_{0} , ψ \cdot {t}_{1} , … ψ \cdot {t}_{\frac{N}{2} - 1} ]}^{T} \qquad Equation 7$$

It should be noted that all elements in the Gramian matrix are independent of the captured correlation triangle ψ and depend only on the base triangles initially selected. Therefore, it is therefore only necessary to derive the Gramian matrix and its inverse R⁻¹ once, which allows computational complexity to be easily managed.

The expressions in Equations 2 and 3 show the mathematical relationship between the amplitudes of two adjacent base triangles. From these equations, a more general form that considers the signs of the amplitudes Ci can be obtained that allows the phase of the measured correlation triangle to be determined from the amplitudes of the linear combination of the base triangles. Due to the periodicity of the phase, two different cases should be considered. In the first case, the phase of the correlation triangle lies between the phase of the first base triangle t₀ and the negative copy of the last triangle t_{N/2-1}. This is the case for C₀>0 and C_{N/2-1}<0. The general expression of the relationship between the phase of the correlation triangle and its amplitude distribution for this case is:

$$ϕ = \frac{- {NC}_{0} + {\sum }_{i = 1}^{\frac{N}{2} - 1} ( \begin{matrix}\frac{sign ( {C}_{i} ) + 1}{2} {iC}_{i} + \\ \frac{sign ( {C}_{i} ) - 1}{2} ( i + \frac{N}{2} ) {C}_{i}\end{matrix} )}{{\sum }_{i = 0}^{\frac{N}{2} - 1} \vert {C}_{i} \vert} \frac{2 π}{N} \qquad Equation 8$$

For any other case, the relationship is expressed as:

$$ϕ = \frac{{\sum }_{i = 0}^{\frac{N}{2} - 1} ( \frac{sign ( {C}_{i} ) + 1}{2} {iC}_{i} + \frac{sign ( {C}_{i} ) - 1}{2} ( i + \frac{N}{2} ) {C}_{i} )}{{\sum }_{i = 0}^{\frac{N}{2} - 1} \vert {C}_{i} \vert} \frac{2 π}{N} \qquad Equation 9$$

The signal processing algorithm uses the principles described above with reference to Equations 1-9 on each of the first and second correlation triangles that are obtained by cross-correlating the combined modulated optical signal with the reference clock signal that is used to drive the light source of the transceiver 2. Once the first and second phase values have been obtained using this process, the signal processing algorithm or a separate algorithm performed by the same or a different processor takes the difference between the phase values is taken to obtain the phase difference value.

Based on the time delay between the measurement optical signal and the reference optical signal providing a phase shift between the signals of 90°, the length of the reference path should be longer than or shorter than the length of the measurement path by one-quarter wavelength. The reference path extends from output port 4c of the splitter 4 to input port 6b of the combiner 6 and the measurement path extends from output port 4b of the splitter 4 to input port 6a of the combiner 6.

Assuming for exemplary purposes that a modulation frequency, f_{mod}, of 250 megahertz (MHz) is used to modulate the light source, the difference between the lengths of the reference path and measurement path should be the modulation wavelength of 120 centimeters (cm) divided by four, or 30 cm, with a suitable tolerance. For ease of explanation, this calculation assumes that the optical signals travel through the optical fiber at the speed of light in a vacuum, although optical signals actually travel slower than the speed of light in a vacuum in optical fiber. The phase shift that is needed is about 90°±45°, depending on the number, N, of discrete phase steps that are used to represent the correlation triangles. For a phase shift of 90°, a suitable tolerance is about ±11°, which leads to a tolerance of about ±3.6 cm for the path length difference. In other words, the nominal path length difference can be set to 150 cm (120 cm+30 cm), 270 cm (240 cm+30 cm), etc., plus or minus a selected tolerance. The tolerance of about ±11° is based on using 16 phase steps and presupposes that one correlation triangle is decomposed into four base triangles in the triangle domain) (180°/16=11.25°). In the case where, for example, 32 phase steps are used, the suitable tolerance would be ±45°.

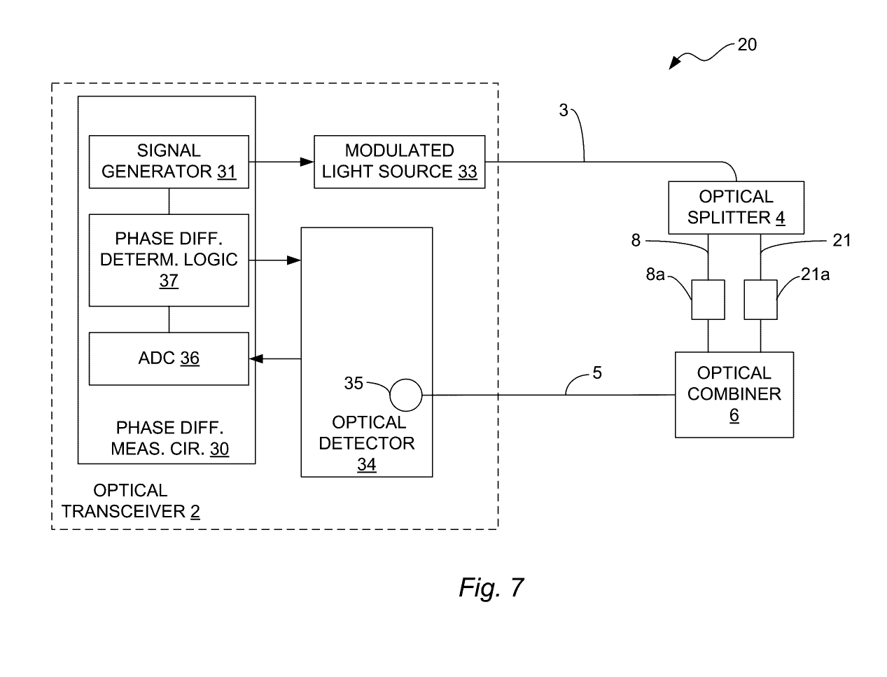

FIG. 7 illustrates the optical fiber strain sensor system 20 shown in FIG. 2 showing an illustrative embodiment of the components of the optical transceiver 2. The optical transceiver 2 includes a phase difference measurement circuit 30 that includes a signal generator 31 for generating an electrical modulated drive signal that drives a light source 33 of the optical transceiver 2. The light source 33 is typically an LED or a laser diode, but may be any suitable light source. The light source 33 generates a modulated optical signal of a particular frequency, f_{MOD}. The modulated optical signal is transmitted over the transmit optical fiber 3 to the optical splitter 4, which is located at the structure (not shown). The optical splitter 4 receives the modulated optical signal of frequency f_{MOD} and splits the modulated optical signal into the measurement and reference modulated optical signals of frequency f_{MOD}.

The reference and measurement modulated optical signals are optically coupled by the splitter 4 into first ends of the measurement and reference optical fibers 8 and 21, respectively. Box 8a represents a meander of the measurement optical fiber 8 of a particular known length disposed in the measurement path for carrying the measurement modulated optical signal. Likewise, box 21a represents a meander of the reference optical fiber 21 of a particular known length disposed in the reference path for carrying reference optical signal. It should be noted that the fibers 8/8a and 21/21a could be replaced with some other type of optical waveguide.

The second ends of the measurement and reference optical fibers 8 and 21 are connected to the optical combiner 6, which combines the measurement and reference modulated optical signals into the combined modulated optical signal. The combined modulated optical signal is then delivered to an optical detector 34 of the optical transceiver 2. The optical detector 34 may be any suitable optical detector including, for example, a PIN diode, an APD, an SPAD, a photo transistor, a charge coupled device (CCD), etc.

The meander of measurement fiber 8a is secured to a structure (not shown) in such a way that stress or strain on the structure will result in elongation of the fiber 8a. The meander of reference fiber 21a is typically placed alongside the meander of measurement fiber 8a on the same structure, but is not secured to the structure in a way that will result in the meander of reference fiber 21a becoming elongated due to strain or stress in the structure. For example, the meander of measurement fiber 8a may be secured to the structure at multiple contact points between the structure and the fiber 8a whereas the meander of reference fiber 21a may be secured to the structure at only one contact point between the structure and the fiber 21a. Thus, stress on the structure will stretch the measurement fiber 8a, but will not stretch the reference fiber 21a.

The optical detector 34 is typically an integrated circuit (IC) die that contains one or more photo sensitive elements 35 that convert the combined modulated optical signal into an analog modulated electrical signal. The cross-correlation algorithm is typically performed in the analog domain inside of the optical detector 34 and then the remainder of the signal processing algorithm is performed in the digital domain in the phase difference determination logic 37. If the photo sensitive element 35 is a SPAD, for example, the cross-correlation algorithm may be performed in the digital domain. An analog-to-digital converter (ADC) 36 of the phase difference measurement circuit 30 converts the analog electrical signal output from the optical detector 34 into a digital electrical signal and outputs the digital electrical signal to phase difference determination logic 37 of the phase difference measurement circuit 30.

The phase difference determination logic 37 performs the above described signal processing algorithm that decomposes the first and second correlation triangles into first and second sets of base triangles, respectively. The signal processing algorithm then processes the amplitudes of the base triangles based on the principles expressed in Equations 1-9 and the Method of Least Squares to obtain the first and second phases of the first and second correlation triangles, respectively. The signal processing algorithm then takes the difference between the first and second phases to produce the phase difference between the measurement and reference modulated optical signals.

The phase difference determination logic 37 is a processor of some type, such as, for example, a microprocessor, a microcontroller, a field programmable gate array (FPGA), a digital signal processor (DSP), an application specific integrated circuit (ASIC), etc. The logic 37 may be any type of processing device capable of being programmed or configured to perform the processing tasks described above with reference to FIG. 7. The logic 37 may be implemented on a single IC die or it may be a combination of IC dies implemented on a circuit board, such as a printed circuit board (PCB), a printed wiring board (PWB), or a flex circuit, for example. The entire phase difference measurement circuit 30, the light source 33 and the optical detector 34 may be implemented on a single die, or they may be implemented on separate dies and mounted on the same or different circuit boards.

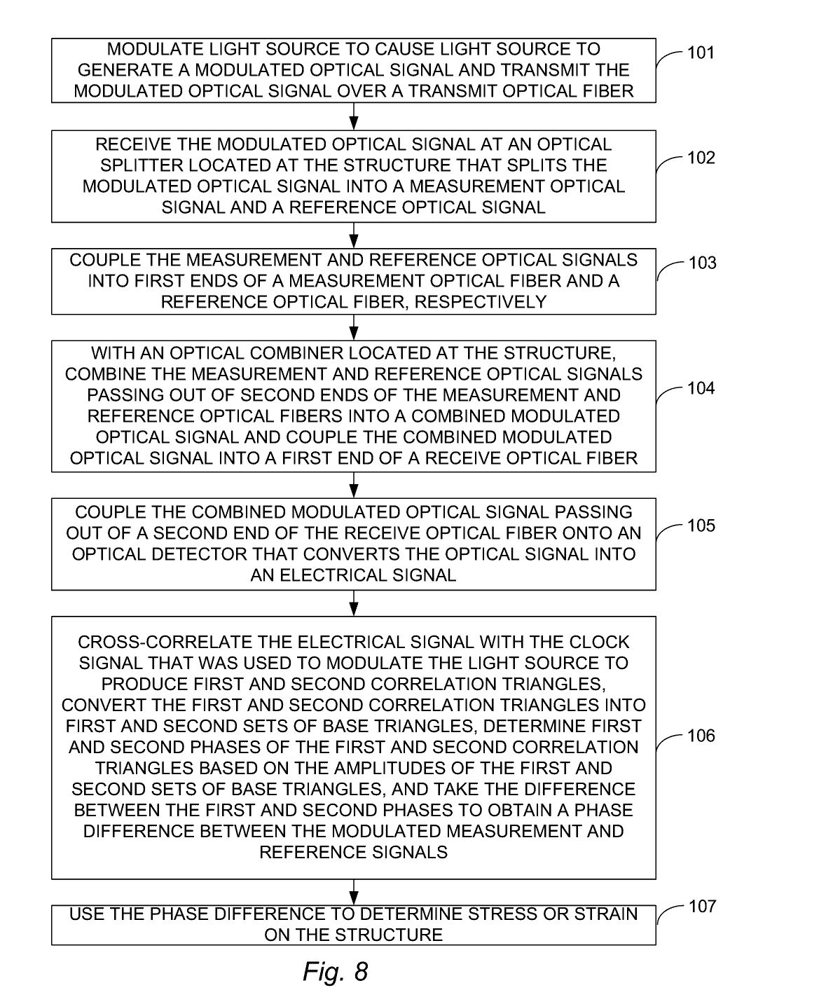

FIG. 8 illustrates a flowchart that represents the method in accordance with an illustrative embodiment for sensing strain in an optical fiber using a system of the type shown in FIGS. 1, 2 and 7. A light source is modulated with a modulation signal to cause the light source to generate an optical signal and the modulated optical signal is transmitted over a transmit optical fiber, as indicated by block 101. The modulated optical signal is received by an optical splitter that splits the modulated optical signal into a measurement optical signal and a reference optical signal, as indicated by block 102. The measurement and reference optical signals are coupled into first ends of a measurement optical fiber and a reference optical fiber, respectively, as indicated by block 103. The reference and measurement optical signals passing out of second ends of the reference and measurement optical fibers, respectively, are combined by an optical combiner located at the structure into a combined optical signal and coupled into a first end of a receive optical fiber, as indicated by block 104. The combined optical signal travels along the receive optical fiber, passes out of the second end of the receive optical fiber and is coupled onto an optical detector, which converts it into an electrical signal, as indicated by block 105.

The electrical signal is then cross-correlated with the modulation signal that was used to modulate the light source to produce first and second correlation triangles, the first and second correlation triangles are converted into first and second sets of base triangles, respectively, first and second phases of the first and second correlation triangles are determined based on the amplitudes of the first and second sets of base triangles, respectively, and the difference between the first and second phases is taken to produce a phase difference between the reference and measurement optical signals, as indicated by block 106. The phase difference may then be used to determine stress or strain on the structure, as indicated by block 107.

It should be noted that signal processing algorithms other than the signal processing algorithm may be used to extract the phases of the reference and measurement optical signals from the combined optical signal. The cross-correlation/Method of Least Squares algorithm described herein is an example of a suitable signal processing algorithm, although the invention is not limited to using this algorithm for this purpose, as will be understood by persons of skill in the art in view of the description being provided herein. Any signal processing algorithm that is capable of extracting the phases of individual signals from a superimposition of those signals is suitable for use with the invention.

It should also be noted that the electrical signal that is produced by the optical detector of the transceiver 2 and the clock signal that is used by the driver circuitry of the transceiver 2 to drive the light source of the transceiver 2 are described above as being of rectangular or rectangular-like shape, they may be of sinusoidal shape or of any periodic shape. The rectangular or rectangular-like shape is only needed when the particular cross-correlation and Method of Least Squares algorithms are being used to extract the phases of the measurement and reference optical signals, as will be understood by those of skill in the art in view of the description being provided herein.

The signal processing algorithm is typically implemented as computer software or firmware stored on a non-transitory computer-readable medium (CRM). The CRM is typically a component of the phase difference measurement circuit 30 and may be part of the phase difference determination logic 37, for example. The CRM may be any suitable CRM including, for example, solid state memory devices (e.g., random access memory (RAM) devices, read-only memory (ROM) devices, programmable ROM (PROM) devices, erasable PROM (EPROM) devices, flash memory devices, etc.), magnetic memory devices (e.g., hard disks), and optical storage devices (e.g., compact discs).

It should be noted that embodiments have been described herein for the purpose of demonstrating the principles and concepts of the invention. As will be understood by persons skilled in the art in view of the description being provided herein, the invention is not limited to these embodiments. For example, while the fiber strain sensor systems 1 and 20 are shown as having particular components, other components capable of performing the tasks described above can be used and the systems 1 and 20 may contain additional components or fewer components than what is shown in FIGS. 1, 2 and 7. Also, variations can be made to the methods described above with reference to FIG. 8 without deviating from the principles and concepts of the invention. Persons of skill in the art will understand that these and other modifications may be made to the embodiments described herein without deviating from the principles and concepts of the invention and that all such modifications are within the scope of the invention.

What is claimed is:

1. An optical fiber strain sensor system comprising:
an optical transceiver;
a transmit optical fiber, wherein a modulated optical signal produced by a light source of the optical transceiver is coupled into a first end of the transmit optical fiber and passes out of a second end of the transmit optical fiber;
an optical splitter, wherein the optical splitter receives the modulated optical signal that passes out of the second end of the transmit optical fiber and splits the modulated optical signal into a modulated measurement optical signal and a modulated reference optical signal;
a measurement optical fiber secured to a structure being measured for stress or strain, wherein the modulated measurement optical signal is coupled into a first end of the measurement optical fiber and passes out of a second end of the measurement optical fiber;
a reference optical fiber, wherein the modulated reference optical signal is coupled into a first end of the reference optical fiber and passes out of a second end of the reference optical fiber;
an optical combiner that receives the modulated measurement and reference optical signals passing out of the second ends of the measurement and reference optical fibers, respectively, and combines the measurement and reference optical signals into a combined modulated optical signal; and
a receive optical fiber that receives the combined modulated optical signal at a first end thereof that passes out of a second end thereof, the combined modulated optical signal being inputted into the optical transceiver, wherein the optical transceiver processes the electrical signal to determine a phase difference between the modulated measurement and reference optical signals.

2. The optical fiber strain sensor system of claim 1, wherein the optical splitter is located in close proximity to the structure.

3. The optical fiber strain sensor system of claim 2, wherein the optical combiner is located in close proximity to the structure.

4. The optical fiber strain sensor system of claim 1, wherein the optical transceiver determines a change in a length of the measurement optical fiber caused by stress or strain in the structure based on the determined phase difference.

5. The optical fiber strain sensor system of claim 1, wherein the system further comprises an optical delay element that delays the modulated measurement optical signal by a predetermined time delay relative to the modulated reference optical signal or that delays the modulated reference optical signal by a predetermined time delay relative to the modulated measurement optical signal.

6. The optical fiber strain sensor system of claim 5, wherein the predetermined time delay is selected based on a wavelength of a clock signal that is used to drive the light source of the optical transceiver, the predetermined time delay being selected to provide a phase delay of the modulated measurement optical signal relative to the reference optical signal of about 90°±45° or to provide a phase delay of the modulated reference optical signal relative to the measurement optical signal of about 90°±45°.

7. The optical fiber strain sensor system of claim 6, wherein the optical transceiver cross-correlates the electrical signal produced by the optical detector with the clock signal that is used to drive the light source of the optical transceiver to produce first and second correlation triangles, and wherein the optical transceiver processes the first and second correlation triangles to extract the phase of the modulated measurement optical signal and the phase of the modulated reference optical signal.

8. The optical strain sensor system of claim 5, wherein the delay element is a delay optical fiber connected in line with either the reference optical fiber or the measurement optical fiber.

9. The optical strain sensor system of claim 5, wherein the delay element is implemented as a length difference between the lengths of the reference and measurement optical fibers, the length difference being preselected to achieve the predetermined time delay.

10. An optical fiber strain sensor system comprising:
a modulated light source of the is modulated with an electrical modulation signal and produces a modulated optical signal;
a first transmit optical waveguide that receives the modulated optical signal at a first end thereof that passes out of a second end thereof;
an optical splitter that receives the modulated optical signal and splits the modulated optical signal into a modulated measurement optical signal and a modulated reference optical signal, the modulated measurement and reference optical signals passing out of respective output ports of the optical splitter;
a measurement optical waveguide that receives the modulated measurement optical signal at a first end thereof that passes out of a second end thereof, the measurement optical waveguide being mechanically coupled to a structure or material such that strain or stress in the structure or material produces strain or stress in the measurement optical waveguide;
a reference optical waveguide that receives the modulated reference optical signal at a first end thereof that passes out of a second end thereof;
an optical combiner that combines the modulated measurement and reference signals passing out of the second ends of the measurement and reference optical waveguides to produce a combined modulated optical signal;
a receive optical waveguide that receives the combined modulated optical signal at a first end thereof that passes out of a second end thereof; and
measurement equipment that receives the combined modulated optical signal passing out of the second end of the receive optical waveguide, the measurement equipment including an optical detector that converts the received combined modulated optical signal into an electrical detection signal, the measurement equipment including circuitry that cross-correlates the electrical detection signal with the electrical modulation signal to produce first and second correlation triangles, decomposes the first and second correlation triangles into first and second sets of base triangles and then determines first and second phases based on amplitudes of the base triangles of the first and second sets, respectively, the first and second phases corresponding to phases of the modulated measurement and reference optical signals, respectively, and wherein the measurement equipment obtains a phase difference between the phases of the modulated measurement and reference optical signals.

11. A method for sensing strain or stress in a structure, the method comprising:
coupling a modulated optical signal into a first end of a transmit optical fiber, wherein the modulated optical signal passes out of a second end of the transmit optical fiber;
with an optical splitter, splitting the modulated optical signal passing out of the second end of the transmit optical fiber into a modulated measurement optical signal and a modulated reference optical signal;
coupling the modulated measurement and reference optical signals into first ends of a measurement optical fiber and a reference optical fiber, respectively, the measurement optical fiber being secured to the structure in such a way that stress in the structure creates stress in the measurement optical fiber, wherein the modulated measurement and reference optical signals pass out of second ends of the measurement and reference optical fibers, respectively;
with an optical combiner, combining the modulated measurement and reference optical signals passing out of the second ends of the measurement and reference optical fibers, respectively, into a combined modulated optical signal;
with a receive optical fiber, receiving the combined modulated optical signal at a first end thereof that passes out of a second end thereof; and
with the measurement equipment, converting the combined modulated optical signal passing out of the second end of the receive optical fiber into an electrical signal and processing the electrical signal to determine a phase difference between the modulated measurement and reference optical signals.

12. The method claim 11, wherein the optical splitter is located in close proximity to the structure.

13. The method of claim 12, wherein the optical combiner is located in close proximity to the structure.

14. The method of claim 11, wherein the measurement equipment determines a change in a length of the measurement optical fiber caused by stress or strain in the structure based on the determined phase difference.

15. The method of claim 11, further comprising:
prior to the modulated measurement and reference optical signals being combined by the optical combiner, using a delay element to delay the modulated measurement optical signal by a predetermined time delay relative to the modulated reference optical signal or to delay the modulated reference optical signal by a predetermined time delay relative to the modulated measurement optical signal.

16. The method of claim 15, wherein the predetermined time delay is selected based on a wavelength of a clock signal that is used to drive a light source that generates the modulated optical signal that is coupled into the first end of the transmit optical fiber, the predetermined time delay being selected to provide a phase delay of the modulated measurement optical signal relative to the modulated reference optical signal of about 90°±45° or to provide a phase delay of the modulated reference optical signal relative to the modulated measurement optical signal of about 90°±45°.

17. The method of claim 16, wherein the electrical signal produced by the optical detector and the clock signal are periodic waveforms.

18. The method of claim 17, wherein the measurement equipment cross-correlates the electrical signal measurement equipment with the clock signal that is used to drive the light source to produce first and second correlation triangles, and wherein the measurement equipment processes the first and second correlation triangles to extract the phase of the modulated measurement optical signal and the phase of the modulated reference optical signal.

19. The method of claim 15, wherein the delay element is a delay optical fiber connected in line with either the reference optical fiber or the measurement optical fiber.

20. The method of claim 15, wherein the delay element is implemented as a length difference between the lengths of the reference and measurement optical fibers, the length difference being preselected to achieve the predetermined time delay.
